(19) United States
(12) Patent Application Publication
(10) Pub. No.: US 2010/0161731 A1
(43) Pub. Date: Jun. 24, 2010

(54) Document-Centric Architecture for Enterprise Applications

(75) Inventors: Surendra Reddy, San Jose, CA (US); Jagadish Changavi, Cupertino, CA (US)

Correspondence Address: FSP LLC, P.O. BOX 890, VANCOUVER, WA, 98666, US

(73) Assignee: Amitive, San Mateo, CA (US)

(21) Appl. No.: 12/642,741

(22) Filed: Dec. 18, 2009

Related U.S. Application Data
(60) Provisional application No. 61/139,446, filed on Dec. 19, 2008.

(51) Int. Cl. G06F 15/16

(52) U.S. Cl. 709/205

(57) ABSTRACT

An enterprise application may include logic to form an association between multiple memory regions each representing a document zone, logic to form memory regions representing collaborative states for each zone and to maintain the collaborative states independently of other zones, and logic to form memory regions representing workflow states for each zone and to maintain the workflow states independently of other zones.

### PRIORITY CLAIM

This application claims priority under 35 USC 119 to U.S. application No. 61/139,446 filed on Dec. 19, 2008, which is presently pending and which is incorporated by reference herein in its entirety.

### BACKGROUND

Traditional enterprise application development may be divided into two categories: best-practice based, and customer-specific development. Best-practice based enterprise application development provides generic solutions based on the best practice of certain industries and/or business domains. The majority of enterprise application vendors, such as SAP™, Oracle™, and Salesforce™ take this approach. Due to the massive user base, the development with this approach can reduce costs while providing software of good quality. However, customers of this category can only distinguish their business processes through limited customizations. Customers end up using the vendors' business processes, rather than their own.

Business processes are valuable assets in a company, especially in companies with effective business processes and/or long history. A customer-specific enterprise application is developed for a specific customer. Therefore, it should meet the exact needs of a specific customer. Companies such as WalMart and Dell adopt this approach. However, a customer-specific business application normally costs more and the coding quality may be poor due to the limited user base. As business competition increases, customers seek business applications that are developed specifically for their business needs, but with low cost and high code quality.

More and more business solutions need to cross organizational boundaries internally and externally. New business solutions need to integrate with existing enterprise applications. It is difficult to make a data model from a vendor fit one from another vendor. It may even be difficult to make a data model from one system fit another system from the same vendor. Therefore, new business solutions require business processes with flexible and extensible data models.

There is an ongoing need for new business application development systems that can support customer-specific development with good code quality and low cost.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is an illustration of a machine configuration for operation of enterprise application logic.

FIGS. 2-4 are illustrations of embodiments of device memory organizations for implementing aspects of enterprise application logic.

FIG. 5 is an illustration of an embodiment of a device memory organization for implementing a workflow.

FIG. 6 is an illustration of an embodiment of a device memory organization for implementing a collaborative flow.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

Overview

Described herein is a document-centric architecture for enterprise application development. This architecture separates an enterprise application system into two parts: platform and community. The platform supports a document-centric infrastructure that provides infrastructure level implementations based on documents, including UI, workflow, business rules, accessing permission, internationalization, event triggering and event subscription, integration and customer process specific code. Customer process specific data are the configurations with the components mentioned above. These configurations are provided in community. The implementation of the components in platform is well designed and well developed so that the code quality is good. As the data schema and business process are defined in the community, the enterprise application developed with the document-centric architecture can support customer specific processes.

A new system for developing business applications is described which meets customers' specific business needs while providing for good quality, low development cost, and rapid development.

In this new system, a data schema for documents is defined by customers. This fundementally differs from traditional enterprise application development techniques that employ predefined data schemas with limited customization. An enterprise application is divided into two parts: platform and community. The “platform” part provides the infrastructure implementation. The “community” provides customer-specific configurations, such as definitions for components and services, and data schemas and customer specific code (such as addins, filters, and event handlers).

The majority of the functionality implementation and the architecture of the system is provided by the platform logic. Different enterprise applications may use the same platform with different communities. As more enterprise applications are developed, the quality of the platform improves. Reuse of the platform logic means quality can be maintained to a high standard.

The development cost is reduced because only the community component is changed for new applications. The platform provides the base infrastructure. Developers of an enterprise application see results immediately once they implement the community component.

Enterprise application development begins with documents. The enterprise application comprises a set of document types. A document template implements a document type; for example, a transaction document or a master data document template. In one embodiment, a document type comprises multiple zones, including a single primary zone, and multiple detail zones. Attributes and zones may be categorized. There are a variety of attributes, including String, Float, Note, Image, and functions. An object relational mapping for a document may be automatically generated once the document template is defined.

A “portal” may be employed to add and remove predefined porlets and arrange the layout for portlets. A web portal may act as a gateway for users to access functionalities of an enterprise application, Types of portals include general portals and specialized or niche portals. Some major general portals include Yahoo™, CNET™, AOL™, and MSN™ Third party applications may interact with the enterprise application through an integration channel. “Portlets” are pluggable user interface logic components that are managed and displayed in a portal. A portlet is generated automatically from a document type and document template.

Multiple level event triggering and processing is supported. Events may be processed closer to where they are generated. Low level events may be reported and aggregated to high level events.

Internationalization is supported based on document templates.

Document template integration is supported with a varity of external data sources, such as FTP, web service, RSS, HTTP, and database. Syntactic and semantic validation is provided for document templates.

All the configuration and definition for document type, document template, portlet, event definition, workflow, and access permission may be defined as metadata using, for example, XML. In one embodiment, platform and community logic are built with Java technology. Implementation may also be accomplished with other technologies, such as Microsoft® “Dot net”® technology.

The term “enterprise application” refers to device logic that when put into operation on a data processing machine or machines facilitates techniques described herein.

### Physical Implementation of a Preferred Embodiment

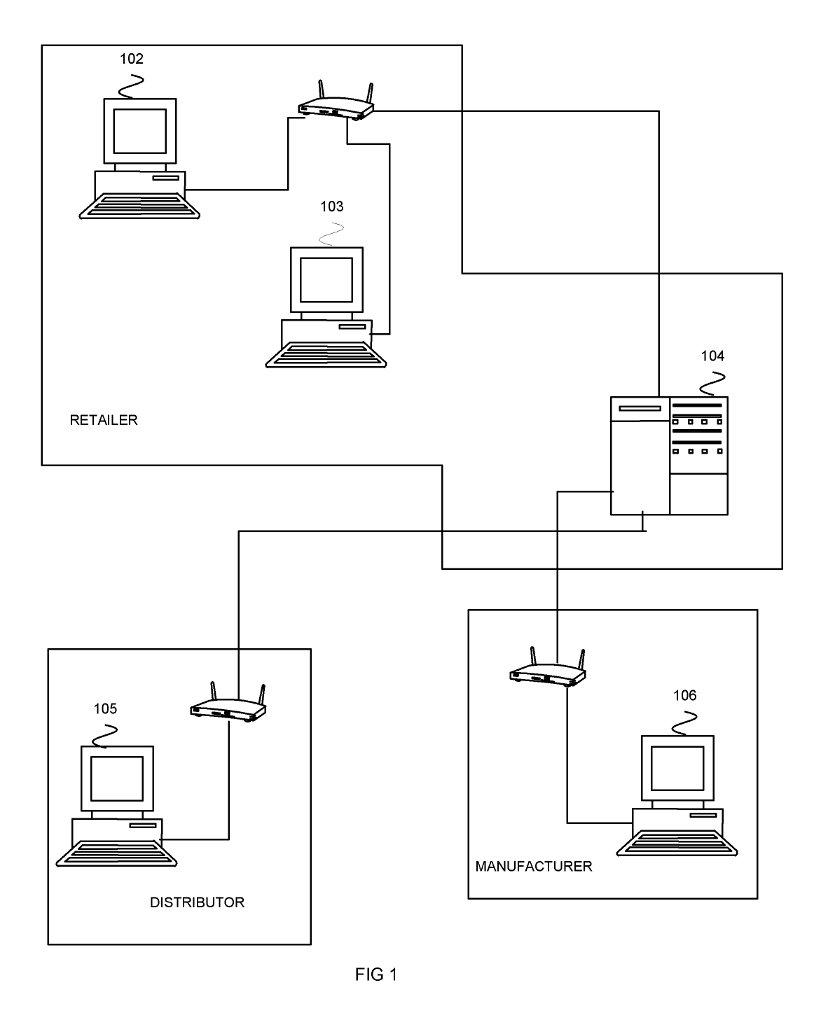

FIG. 1 is an illustration of one embodiment of an environment for enterprise application logic deployment. Application logic may operate on a central computer system 104 of a retailer or other member of a business community. The central system 104 may in some cases represent devices operated by multiple members of the community, over which the application logic is distributed. For example, the application logic may implement operations of a supply chain management function.

Members of the business community may each comprise data processing devices to interact with the enterprise application logic. For example, the retailer may comprise devices 102, 103, the manufacturer device 106, and the distributer device 105. Of course, the number and distribution of devices among community members will vary in specific deployments.

The application logic may operate across organizational boundaries. Permissions, workflow, user interface, events, notifications, and collaboration may all span organization boundaries.

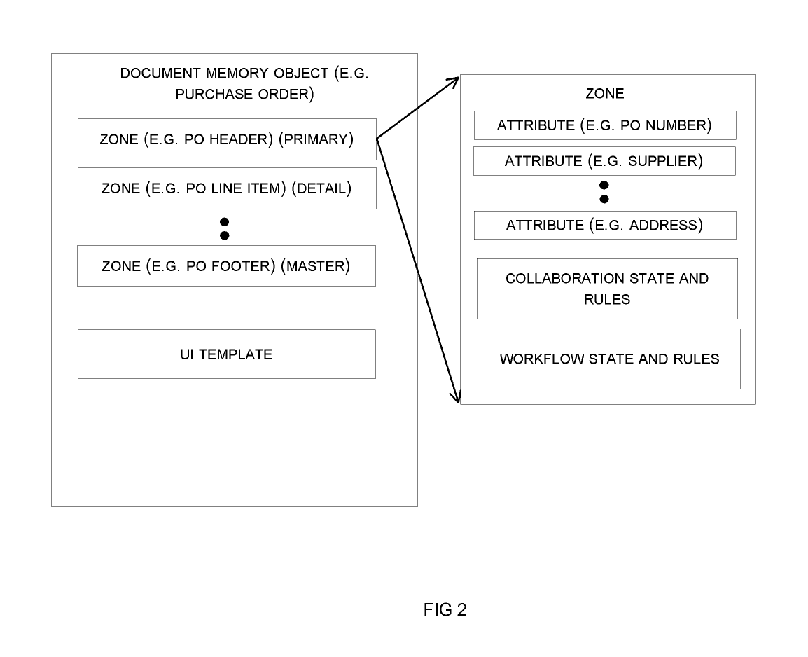

FIG. 2 is an illustration of an embodiment of a device memory organization for implementing aspects of enterprise application logic. The device memory organization may be formed by logic to form an association between multiple memory regions each representing a “document zone”. A document zone is a set of organizational data comprising machine-data values (memory or other circuits configured into physical states often representative of physical articles, devices, materials, and/or quantities thereof) that has some inter-relationship for purposes of workflow or collaboration. The enterprise application may further comprise logic to form memory regions representing collaborative states and/or rules (conditions and/or actions) for each document zone and to maintain the collaborative states/rules independently of other document zones. Thus, a set of related organizational information in a zone may be operated upon and managed through an independent work and collaborative lifecycle. The enterprise application may further comprise logic to form memory regions representing workflow states/rules for each zone and to maintain the workflow states/rules independently of other zones.

The logic to form an association between multiple memory regions each representing a document zone may operate responsive to a metadata definition for the document zones. An example of such a metadata definition is provided in Listing 1.

Listing 1 - Example of metadata to effect memory
organization by enterprise application logic

<zone doc-type-zone-ref=“PO_HDR”name=“AAA_PO_HDR”
display-name=“Purchase Order Header” >

<element name=“order_num”

search=“y” generated-business-key=“y”/>

<element name=“supplier name”

type=“reference” doc-template-ref=“CST_PARTY_DOC”

zone-ref=“cst_primary” element-ref=“NAME”

mandatory=“y” is-party=“y”/>

<element name=“order_date”

mandatory=“y” search=“y” default-value=“current_date”/>

<element name=“ship_to”

type=“reference” doc-template-ref=“FACILITY”
zone-ref=“FACI_HDR” element-ref=“FACILITY_NAME”

mandatory=“y” />

<element name=“receipt_type” type=“reference”

doc-template-ref=“LOVTYPECODE”
zone-ref=“LOV_TYPE_HEADER”
element-ref=“LOV_TYPE_CODE” />

<element name=“notes” />
<element name=“attachments” />
</zone>

A Header Zone “AAA_PO_HDR” for document template “AAA_PO” is defined in Listing 1. The display name of this zone is “Purchase Order Header”. This header zone has seven data elements: “order_num”, “supplier_name”, “order_date”, “ship_to”, “receipt_type”, “notes” and “attachments”.

In Listing 1, an element may have the following attributes: name, type, mandatory, search, updatable, generate-business-key, doc-template-ref, zone-ref, collaborate, values and default-value. Mandatory, search, updatable, and collaborate have Boolean value: “yes” or “no” to decide whether the element will support the specific feature. Doc-template-ref and zone-ref are the reference to document template and zone. Values contain all the potential values and default-value is the default value which should be of the potential values.

The logic to form an association between multiple memory regions, each memory region representing a document zone, may form at least one zone comprising multiple associations to user interface attributes. This may be referred to as a user interface (UI) zone or template. The machine-data contents of this zone may be applied to logic that affects graphics operations of the device according to the user interface attributes, to form a configuration of pixels on a display device (e.g. a ‘user interface’ representing a ‘document’). Listing 2 is an example of metadata that may affect the operation of logic to form a configuration of document pixels on a display device.

Listing 2 - Example of metadata to effect memory organization
and pixel display by enterprise application logic

<ui-template name=″UI_PO_TMPL″ template-ref=″PO_TMPL″ zone-display-type=″list“ >
<ui-zone name=″UI_PO_HDR″

order=″element11, element12, element13″
column=″2″ zone-ref=″PO_HDR″>

<ui-element name=″element11″
ui-type=″″ field-width=″″

hidden=″false″ collapsed=″false″ element-ref=″″/>

<ui-element name=″element12″
ui-type=″″ field-width=″″ hidden=″false″ collapsed=″false″
element-ref=″someElement″/>
</ui-zone>
<ui-zone name=″UI_PO_DETAIL″ number-of-rows=″20″ order=″element1,
element5,element7, element6, element3, element4,element2″ sort-order=″ascending″
default-sorted-column=″element1″ zone-ref=″PO_DETAIL″>
<ui-element name=″element1″ collapsed=″false″ hidden=″false″ ui-type=″password″
field-width=″40″ element-ref=″″/>
<ui-group name=″group1″ display-name=″″ column=″2″>
<ui-element name=″elemnet5″ collapsed=″false″ hidden=″false″ ui-type=″password″
field-width=″40″ element-ref=″″/>
<ui-element name=″element7″ ui-type=″alphanumeric-textbox″ field-width=″40″
element-ref=″″/>
</ui-group><ui-element name=″element6″ collapsed=″false″ hidden=″false″ ui-
type=″password″ field-width=″40″ element-ref=″″/>
<ui-element name=″element3″ collapsed=″false″ ui-type=″notes″ element-ref=″″/>
<ui-group name=″group2″ display-name=″″ column=″2″>
<ui-element name=″element4″ ui-type=″drop-down″ element-ref=″″>
</ui-zone>
</ui-template>

Listing 2 defines a user interface (UI) template “UI_PO_TMPL” which comprises two UI Zones: “UI-PO-HDR” which is a primary zone; and “UI-PO-DETAIL” which is a detail zone. In one embodiment, a document UI may have a single primary zone and multiple detail zones. In Listing 1 there is a single detail zone. One zone can have multiple UI groups. In this example, the primary zone “UI_PO_TMPL” has only one group and the detail zone “UI-PO-DETAIL” has multiple detail zones. One zone comprises multiple elements: ui-element name, collapse, ui-type, field-width and element-ref. Element element-ref references the attribute reference name.

The enterprise application may include logic to relate memory regions each representing an attribute with one another, where the memory regions representing attributes are each associated with different associated document zones. In other words, attributes in different document zones of the same document object may be related to one another.

The enterprise application may include logic to relate memory regions each representing an attribute with one another, where the memory regions representing attributes are each are associated with different unassociated document zones. In other words, attributes in document zones of different document objects may be related to one another.

The enterprise application may include logic to represent in memory one or more conditions against which to evaluate a format or value of data in each of the memory subregions. In other words, the enterprise application may include logic to perform semantic and/or data validation of document zone attributes.

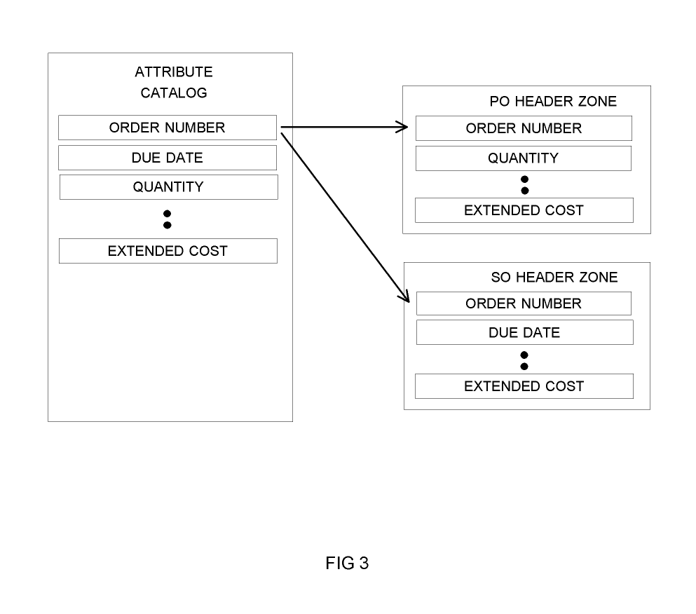

Machine data representing attribute features may be represented in a memory region separate from a particular document or document zone memory object. The enterprise application may include logic to associate multiple subregions of each document zone with memory regions in a central catalogue of document attributes (see FIG. 3). The enterprise application logic may implement memory configurations establishing one-to-many relationships between memory regions representing attributes in document objects and memory regions in a central attribute catalog. This not only results in machine resource utilization efficiency but also enables consistent context for attributes across document objects and zones thereof.

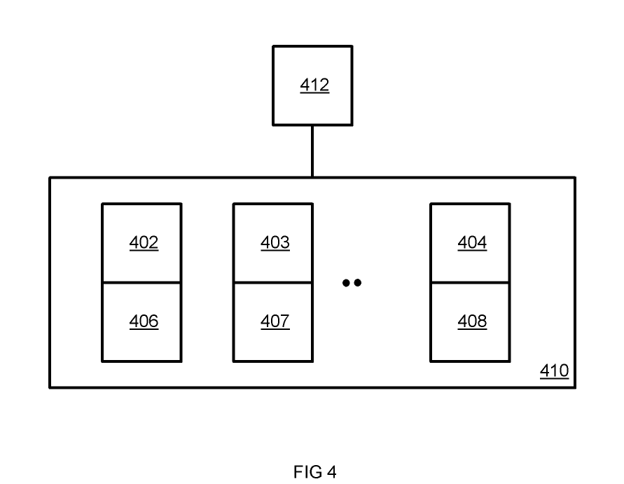

FIG. 4 is an illustration of an implementation of a machine memory configuration to maintain workflow state and define workflow activity for machine data of a document zone. A machine memory configuration 410 in the form of associated memory regions (linked regions) 402-408 is established by enterprise application logic. Each associated region (“node”, e.g. 402 and 406) includes associated machine data representing a machine-evaluated condition and an associated machine-implemented action. The overall configuration includes a memory region 412 comprising machine data representing a workflow state. Thus to implement and track workflow for a document zone, the enterprise application may include logic to form, for each linked memory region (node), a first memory region with data representing a condition, and a second memory region with data representing an action, and to associate the first and second memory regions with one another. A memory region with data representing the state of the workflow may be associated with the linked memory structure of condition-action nodes. Collaborative workflow defines the collaboration on the same content between parties. For example, a leave request may have to be approved by the manager. A collaborative flow memory structure may be created by associating memory regions comprising machine data representing different parties and permissions, with different memory regions of a workflow memory structure. However, the collaborative flow structure may extend beyond the workflow structure by involving multiple documents and actions that may be separate from a particular document and/or event (in some implementations). In other words, collaborative flows may be formed from super-associations of memory regions representing multiple workflows, documents, parties, and so on.

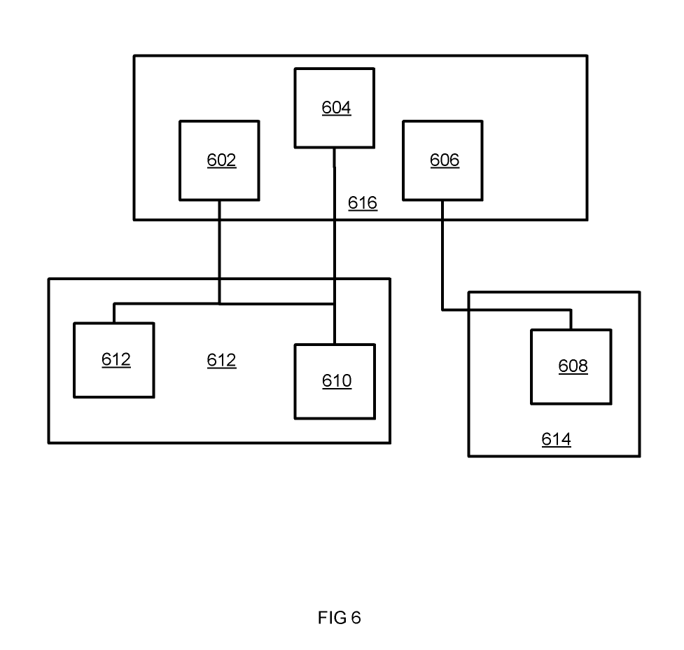

FIG. 6 is an illustration of an embodiment of a device memory organization for implementing a collaborative flow. A machine memory organization 616 representing a collaborative flow may be formed by associating memory regions comprising machine data representing parties (602-606) with workflow memory organizations (608-612) in (for example) multiple document objects (612-614).

One machine action that may be represented by a workflow node is creation of a new document object memory configuration. An enterprise application may thus include logic to form a memory region representing an action that activates logic (1) form an association between multiple memory regions each representing a document zone, (2) form memory regions representing collaborative states for each zone and to maintain the collaborative states independently of other zones, and (3) form memory regions representing workflow states for each zone and to maintain the workflow states independently of other zones.

One of the actions that may be represented by a workflow node is a communication event, such as a notification in the form of an email or other visual or auditory event. An enterprise application may thus include logic to form a memory region representing an action to activate a machine device communication event.

Collaborative flows and workflows may be shared among document zones. Enterprise application logic may thus include logic to make multiple associations between workflow memory configurations and/or collaborative memory configurations and multiple memory region configurations representing document zones. The zones may be in different document objects. In practice, this may involve forming an association between first multiple memory regions each representing zones of a first document, forming memory regions representing collaborative states for each zone of the first document, forming memory regions representing workflow states for each zone of the first document, forming an association between second multiple memory regions each representing zones of a second document, associating with one or more of the second multiple memory regions representing the zones of the second document, one or more of (1) memory regions representing collaborative states for a zone of the first document, or (2) memory regions representing workflow states for a zone of the first document.

Workflows may be shared among document zones, and thus the enterprise application logic may form multiple sets of linked memory regions, each set representing a workflow state, and associate each set of linked memory regions with a different memory region representing a document zone.

The logic to form memory regions representing collaborative states for each zone and to maintain the collaborative states independently of other zones may act responsive to a metadata definition for the collaborative states. Likewise, the logic to form memory regions representing workflow states for each zone and to maintain the workflow states independently of other zones may be responsive to a metadata definition for the workflow states. Listings 3 and 4 are examples of metadata definitions to define collaborative and workflow states and rules.

Listing 3 - Example of metadata to effect memory
organization by enterprise application logic

rule “createReceiptDoc”

rule “createReceiptDoc”

when

primary : Primary(status!=“PENDING”)

then

DocumentCreatorUtil docCreater =

(DocumentCreatorUtil)getBean(DocumentCreatorUtil.class);

RuntimeDocument

doc=docCreater.createDocument(DocumentCreatorUtil.DOCTYPE_RECEIPT,rt);

// publish the event
EventAPI eventAPI=(EventAPI)getBean(EventAPI.class);
eventAPI.publishEvent(“ReceiptCreated”,doc);

end

Listing 3 includes a definition of the rule “createReceiptDoc”. In this example, when the condition primary gets satisfied, a document will be created and an event “ReceiptCreated” will be generated.

Listing 4 - Example of metadata to effect memory
organization by enterprise application logic

<?xml version=″1.0″ encoding=″UTF-8″?>
<process-definition xmlns=″″ name=“PO_Process″>
<start-state name=″Start″>
<transition to=″Draft″ name=″Draft″></transition>
</start-state>
<node name=″Draft″>
<event-action name=″POCreatedEventAction″ event-type=″PO_CREATED″

event-level=″document“

class=″com.mitrix.workflow.jbpm.handlers.EventActionHandler″/>
<class-action name=″SavePOAsDraft″
class=″com.mitrix.po.workflow.handlers.ProcurementSaveAsDraftActionHandler″
config-type=″bean″/>
<transition to=″Pending″ name=″Pending″></transition>
</node>
<task-node name=″Pending″>
<task name=″SubmitPO″>
<assignment pooled-actors=″Submitter″></assignment>
<event-action name=″SubmitPOEventAction″ event-type=″PO_SUBMISSION″

event-level=″document″
class=″com.mitrix.workflow.jbpm.handlers.EventActionHandler″/>

<class-action name=″PODraftToPending″
class=″com.mitrix.po.workflow.handlers.seamm.POPendingApprovalActionHandler″
config-type=″bean″/>
</task>
<transition to=″Approval″ name=″Approval″></transition>
</task-node>
<node name=″Receipt″>
<event-listener name=″POOpenToClose″ event-

type=″RECEIPT_LINE_CREATED″
class=″com.mitrix.po.workflow.handlers.ProcurementOpenToCloseActionHandler

″ config-type=″bean″/>
<transition to=″Close″ name=″Close″></transition>
</node>

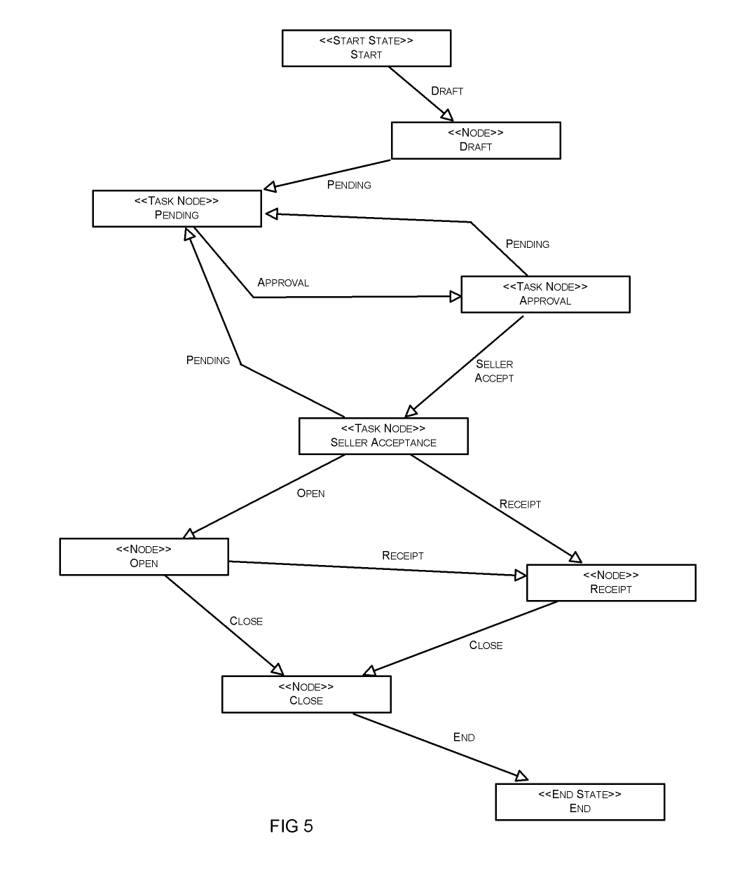

Listing 4 gives the metadata definition of the workflow represented in FIG. 5. A workflow comprises multiple states, such as “Start”, “Draft”, and “Pending”. The workflow begins with the “Start” state. The transition will lead it to the “Draft” state. An event “Publish Event PO-Action” will be generated using the logic defined by the identifier “com.mitrix.workflow.jbpm.handlers.EventActionHandler”. Then the action “SaveP0AsDraft” implemented by logic com.mitrix.po.workflow.handlers.ProcurementSaveAsDraftActionHandler will be called. The transition will lead this workflow to “Pending” state. Tasks are user actions. The “Pending” task will be triggered once a “Submitter” submits a PO. The PO_SUMISSION event from com.mitrix.workflow.jbpm.handlers.EventActionHandler will trigger the task. Then the action PODraftToPending of com.mitrix.po.workflow.handlers.ProcurementSaveAsDraftActionHandler will be invoked. After the transition will change the Workflow state to “Pending”.

Implementations and Alternatives

“Logic” refers to signals and/or information embodied in circuitry (e.g. memory or other electronic or optical circuits) that may be applied to influence the operation of a device. Software, hardware, electrical and optical memory, and firmware are examples of physical structure that may embody logic. Hardware logic may be embodied in circuits. In general, logic may comprise combinations of software, hardware, and/or firmware.

“Metadata definition” refers to a set of machine data values represented as alpha-numeric text, which may be applied to affect the operation of device logic to form memory associations and states.

“Memory region” refers to one or more machine memory circuits maintaining an electrical or optical configuration representative of a data value. The circuits of a machine memory need not necessarily be associated with contiguous ‘addresses’ in a memory circuit, although they may, depending upon the implementation.

Those skilled in the art will appreciate that logic may be distributed throughout one or more devices, and/or may be comprised of combinations of instructions in memory, processing capability, circuits, and so on. Therefore, in the interest of clarity and correctness logic may not always be distinctly illustrated in drawings of devices and systems, although it is inherently present therein.

The techniques and procedures described herein may be implemented via logic distributed in one or more computing devices. The particular distribution and choice of logic is a design decision that will vary according to implementation.

Those having skill in the art will appreciate that there are various logic implementations by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. A device comprising:
logic to form an association between multiple memory regions each representing a document zone;
logic to form memory regions representing collaborative states for each zone and to maintain the collaborative states independently of other zones; and
logic to form memory regions representing workflow states for each zone and to maintain the workflow states independently of other zones.

2. The device of claim 1, further comprising:
logic to associate multiple subregions of each document zone with memory regions in a central catalogue of document attributes.

3. The device of claim 1, further comprising:
logic form multiple sets of linked memory regions, each set representing a workflow state, and to associate each set of linked memory regions with a different memory region representing a document zone.

4. The device of claim 1, further comprising:
the logic to form an association between multiple memory regions each representing a document zone responsive to a metadata definition for the document zones.

5. The device of claim 1, further comprising:
the logic to form an association between multiple memory regions each representing a document zone forming at least one zone comprising multiple associations to user interface attributes; and
logic to effect graphics operations of the device according to the user interface attributes to form a configuration of pixels on a display device.

6. The device of claim 1, further comprising:
logic to relate memory regions each representing an attribute with one another, where the memory regions representing attributes are each associated with different associated document zones.

7. The device of claim 1, further comprising:
logic to relate memory regions each representing an attribute with one another, where the memory regions representing attributes are each are associated with different unassociated document zones.

8. The device of claim 2, further comprising:
logic to represent in memory one or more conditions against which to evaluate a format or value of data in each of the memory subregions.

9. The device of claim 3, further comprising:
logic form, for each linked memory region, a first memory region with data representing a condition, and a second memory region with data representing an action, and to associate the first and second memory regions with one another.

10. The device of claim 9, further comprising:
logic to form a second memory region representing an action to activate the logic described in claim 1.

11. The device of claim 9, further comprising:
logic to form a second memory region representing an action to activate a device communication event.

12. The device of claim 1, further comprising:
logic to form an association between first multiple memory regions each representing zones of a first document;
logic to form memory regions representing collaborative states for each zone of the first document;
logic to form memory regions representing workflow states for each zone of the first document;
logic to form an association between second multiple memory regions each representing zones of a second document; and
logic to associate with one or more of the second multiple memory regions representing the zones of the second document, one or more of:
memory regions representing collaborative states for a zone of the first document, or
memory regions representing workflow states for a zone of the first document.

13. The device of claim 1, further comprising:
the logic to form memory regions representing collaborative states for each zone and to maintain the collaborative states independently of other zones responsive to a metadata definition for the collaborative states; and
the logic to form memory regions representing workflow states for each zone and to maintain the workflow states independently of other zones responsive to a metadata definition for the workflow states.

14. The device of claim 1, further comprising:
the logic to form memory regions representing collaborative states for each zone and to maintain the collaborative states independently of other zones comprising logic to associate memory regions representing parties that will perform actions on the document with workflow states and/or events.

15. The device of claim 14, further comprising:
the logic to form memory regions representing collaborative states for each zone and to maintain the collaborative states independently of other zones comprising logic to associate memory regions representing parties that will perform actions on the document with workflow states and/or events in multiple document objects.
